(19) United States
(12) Patent Application Publication
(10) Pub. No.: US 2006/0029529 A1
(43) Pub. Date: Feb. 9, 2006

(54) Pressurized hydrogen delivery system for electrochemical cells

(76) Inventors: Frederick E. Pinkerton, Shelby Township, MI (US); Gregory P. Meisner, Ann Arbor, MI (US); Michael P. Balogh, Novi, MI (US); Martin S. Meyer, Southfield, MI (US)

Correspondence Address: Kathryn A. Marra;General Motors Corporation, Legal Staff - Mail Code 482-C23-B21, P.O. Box 300 - 300 Renaissance Center, Detroit, MI, 48265-3000, US

(21) Appl. No.: 10/910,066

(22) Filed: Aug. 3, 2004

(51) Int. Cl. B01J 3/00; H01M 8/06

(52) U.S. Cl. 422/242; 429/19

(57) ABSTRACT

A hydrogen delivery system for a fuel cell is provided that uses hydrogen as a reactant. A fluid storage vessel contains a hydrogen storage material that reversibly releases and stores hydrogen gas. The released hydrogen gas exits the fluid storage vessel, is pressurized by a fluid pressurization device, and then stored in a ballast vessel. The hydrogen gas is delivered as a reactant to the fuel cell from the ballast vessel at a pressure greater than or equal to the operating pressure of the fuel cell. Variations of the above described hydrogen delivery systems are further disclosed, as well as methods of delivering hydrogen to a fuel cell.

### FIELD OF THE INVENTION

The present invention relates to hydrogen fuel delivery systems for electrochemical fuel cells, and more particularly to hydrogen storage and delivery systems.

### BACKGROUND OF THE INVENTION

Electrochemical fuel cells can be used in a vast array of applications as a power source, including as an alternate power source to the internal combustion engine for vehicular applications. An electrochemical fuel cell contains a membrane sandwiched between electrodes. One preferred fuel cell is known as a proton exchange membrane (PEM), where hydrogen (H₂) is used as a fuel source or reducing agent at an anode electrode and oxygen (O2) is provided as the oxidizing agent at a cathode electrode, either in pure gaseous form or combined with nitrogen and other inert diluents present in air. During operation of the fuel cell, electricity is garnered by electrically conductive elements proximate to the electrodes via the electrical potential generated during the reduction-oxidation reaction occurring within the fuel cell.

A fuel cell stack comprises a plurality of individual cells bundled together into a high voltage pack. It is desirable for many applications, and particularly electric vehicle applications, that the fuel cell stack is capable of being started-up quickly so as to be immediately available to produce the energy needed to propel the vehicle without significant delay. Further, a hydrogen supply must fuel the fuel cell stack during operations. Storing hydrogen in a solid material provides relatively high volumetric hydrogen density and a compact storage medium, which is particularly advantageous for mobile applications. Hydrogen stored in a solid is desirable since it can be released or desorbed under appropriate temperature and pressure conditions, thereby providing a controllable source of hydrogen.

Presently, it is desirable to maximize the hydrogen storage capacity or content released from the material, while minimizing the weight of the material to improve the gravimetric capacity. Further, many current materials only absorb or desorb hydrogen at very high temperatures and pressures. Thus, it is desirable to find a hydrogen storage material, as well as a hydrogen storage and delivery system, that generates or releases hydrogen at relatively low temperatures and pressures, and which have relatively high gravimetric hydrogen storage density.

Therefore, there is a desire for an improved hydrogen storage and delivery system for a fuel cell that optimizes fuel cell performance as cost-effectively as possible.

### SUMMARY OF THE INVENTION

The present invention provides a hydrogen delivery system for use in a fuel cell comprising a fluid storage vessel for housing a hydrogen storage material. The hydrogen storage material stores hydrogen. The delivery system also comprises a fluid ballast vessel for storing and delivering hydrogen to at least one fuel cell. A pressurization device is adapted to pressurize the hydrogen released from the storage material for delivery to the ballast vessel. It is preferred that that the fluid storage vessel does not have a pressure greater than the ballast vessel.

In another aspect, the present invention provides a hydrogen delivery system comprising a fluid storage vessel containing a hydrogen storage material that releases hydrogen gas. The hydrogen delivery system comprises a fluid pressurization device that is in fluid communication with the fluid storage vessel for pressurizing the released hydrogen gas. A fluid ballast vessel is adapted to receive and store the pressurized hydrogen gas from the fluid pressurization device. A hydrogen delivery system further comprises at least one fuel cell which uses the hydrogen gas as a reactant, where the pressurized hydrogen gas is delivered from the ballast vessel to the fuel cell in a fluid stream at a substantially constant pressure.

In another aspect, the present invention provides a method of providing hydrogen reactant to a fuel cell comprising: releasing hydrogen gas from a hydrogen storage material, pressurizing the hydrogen gas, storing the pressurized hydrogen gas in a ballast vessel, and delivering the pressurized hydrogen gas from the ballast vessel to the fuel cell. The pressurized hydrogen gas is preferably at a pressure greater than or equal to an operating pressure of the fuel cell.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a preferred embodiment of a fuel delivery system for a fuel cell stack according to the present invention;

FIG. 2 is a pressure-concentration-temperature (PCT) diagram for an exemplary hydrogen storage material;

FIG. 3 shows an alternate embodiment of a fuel delivery system for a fuel cell stack, wherein a fluid pressurization device and a fluid handling system have a shared drive mechanism; and

FIG. 4 shows another alternate embodiment of a fuel delivery system for a fuel cell stack, having a single fluid pressurization device that serves to both pressurize and transport fluids in a fuel cell system.

### DETAILED DESCRIPTION OF THE PREFERRED EMBODIMENTS

The following description of the preferred embodiment(s) is merely exemplary in nature and is in no way intended to limit the invention, its application, or uses.

In one aspect, the present invention provides an improved fuel delivery system for a fuel cell. In preferred embodiments of the present invention, hydrogen is reversibly stored in a hydrogen storage material. The hydrogen storage material is contained within a fluid storage vessel, such as a tank, for example. As used herein, the term “fluid” is intended to broadly encompass both gases and mixtures of gases, vapors, and liquids, for example, gases having entrained liquids or other diluents. The hydrogen storage material is preferably a solid-state material that has a hydrogenated state and a dehydrogenated state. By subjecting the hydrogenated state of the hydrogen storage material to appropriate temperature and pressure conditions, the hydrogen storage material will release or desorb gaseous hydrogen. In this manner, the hydrogen storage material serves as a solid phase source of hydrogen gas that is used as a fuel (i.e., reactant) in a hydrogen-oxygen PEM fuel cell, for example. Further, in preferred embodiments of the present invention, after all the hydrogen has been released from the hydrogenated state of the hydrogen storage material, the dehydrogenated state of the material can be re-charged with hydrogen gas to regenerate a hydrogenated state of the hydrogen storage material and thus replenish the hydrogen source for the fuel cell. Preferred embodiments of the present invention enable consistent delivery of hydrogen gas to the fuel cell stack at a desirable and substantially constant pressure level. As used herein, the term “substantially” refers to an approximate value that allows for slight deviations or fluctuations in the value. If, for some reason, the imprecision provided by “substantially” is not otherwise understood in the art with this ordinary meaning, then “substantially” as used herein indicates a possible variation of up to 10% in the value.

Previous prior art fuel delivery systems generally have a hydrogen storage device that contains a hydrogen storage material, where the hydrogen storage device is in direct fluid communication with a fuel cell. Such a fuel delivery system generally restricts the range of available materials to those with specific physical characteristics that release hydrogen at temperature and pressure conditions corresponding to the fuel cell's operating conditions. One aspect of the present invention is that the hydrogen storage materials and the operating conditions in the fluid storage vessel are relatively independent of the fuel cell operating conditions (e.g., temperature and pressure) which thus enables a more efficient hydrogen delivery system and expands the range of hydrogen storage materials that may be used (by broadening physical properties requirements), as will be described in greater detail below.

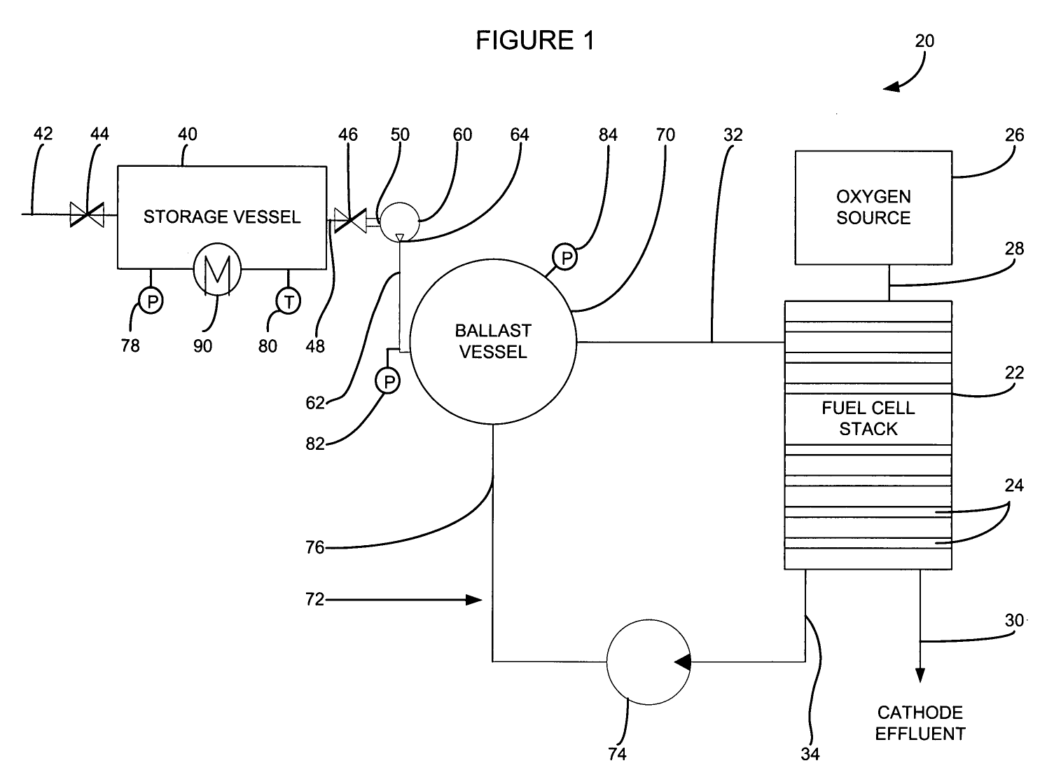

As depicted in FIG. 1, one preferred embodiment of the present invention has a hydrogen delivery system 20 according to the present invention, which comprises an exemplary fuel cell stack 22 which preferably comprises a plurality of fuel cells 24 that use hydrogen and oxygen as reactants. Such fuel cells 24 are preferably proton exchange membrane (PEM) fuel cells, that consume hydrogen at the anode and oxygen at the cathode, and are connected to one another in series in the stack to generate electricity. The fuel cell stack 22 is connected to an oxygen source 26 which delivers oxygen to a cathode side inlet passage 28 as a reactant for the fuel cells 24. The fuel cell stack 22 likewise has a cathode effluent stream 30 exhausted from the fuel cell stack 22. Similarly, the fuel cell stack 22 has an anode side inlet passage 32 through which hydrogen reactant enters the fuel cell stack 22 and an anode outlet passage 34 for removing anode effluent from the stack 22, as will be discussed in greater detail below.

A fluid storage vessel 40 is provided that contains a solid-state hydrogen storage material (not shown). The hydrogen storage material stores hydrogen in a solid hydrogenated state and releases hydrogen gas when exposed to appropriate temperature and pressure conditions to form a dehydrogenated state. The storage vessel 40 has an inlet conduit 42 leading to an inlet valve 44, as well as outlet valve 46 connected to an outlet passage 48. The outlet passage 48 is connected to an inlet 50 to a fluid pressurization device 60. The fluid pressurization device 60 may be any apparatus that increases fluid pressure to correspond to the required operating conditions of the fuel cells 24, and may include compressors, blowers, pumps, and the like. A non-limiting exemplary fluid pressurization device 60, as shown and referred to herein, is a compressor. The fluid pressurization device 60 can be arranged to serve dual functions, as both a fluid circulation device, for circulating fluids in the fuel cell system 20, as well as a fluid pressurization device to increase the pressure of fluids in the fuel cell system 20. A connection passage 62 connects an outlet 64 of the pressurization device 60 to a buffer, or ballast vessel 70, such as a pressurized storage tank, for example. Hydrogen gas that is generated in the fluid storage vessel 40 is thus compressed and pressurized in the fluid pressurization device 60 and then delivered to the ballast vessel 70 via the connection passage 62. It should be noted that a fluid stream comprising hydrogen gas may further comprise diluents and other compounds or components. The ballast vessel 70 stores the pressurized hydrogen gas and delivers it to the fuel-cell stack 22 at a substantially constant pressure as fuel/reactant during normal steady-state operations to the anode inlet passage 32 of the fuel cell stack 22. As used herein, “normal”, “steady-state”, “non-start-up” or “run mode” conditions refer to the operating conditions when temperatures are within typical operating ranges. “Transient” conditions for a fuel cell generally refer to transient operating conditions when the fuel cell is transitioning or being engaged from a cold state (i.e., during start-up) to achieve steady state normal ranges for operating temperature, fuel delivery and electrical output, or during variable operating conditions when a mobile application experiences increased power demand or requires power demand load leveling for relatively short periods of time.

In many fuel cells hydrogen gas reactant is only partially consumed, and the unconsumed portion of hydrogen in the anode effluent is recirculated/recycled back from the anode outlet 34 to the anode inlet 32 in a fluid handling system 72 configured to have a recycle/recirculation loop. In preferred embodiments of the present invention, the fuel cell stack system 20 comprises the fluid handling system 72 which comprises a fluid handling device 74, such as for example, a pump, compressor, or blower, for circulating fluids through the system 20 to and from the fuel cell stack 22. In the embodiment as shown in FIG. 1, the recirculation loop fluid handling system 72 further comprises conduit or recirculation passages 76 for transporting fluids. In the configuration as shown, the fluid handling system/recirculation loop 72 connects to the ballast vessel 70, where fluids from the recirculation loop 72 combine with the hydrogen gas originating in the storage vessel 40. The pressure of the hydrogen gas from the fluid handling system 72 is generally similar to the pressure of the stack 22 and hence, the operating fuel cells 24. The mixture of fluids in the ballast vessel 70 thus comprises both the hydrogen gas released from the hydrogen storage material pressurized by the fluid pressurization device 60 and the recycled hydrogen gas from the pressurized recirculation loop 72, and as well as any other diluent fluids and components (e.g., water or nitrogen). Thus, in certain preferred embodiments, the fuel delivery system 20 comprises an anode side assembly (comprising a plurality of anodes of the plurality of fuel cells 24) in the stack 22, where the ballast vessel 70 supplies hydrogen to an inlet 32 of the anode assembly, and the ballast vessel 70 receives effluent from an outlet 34 of the assembly.

It should be noted that it is within the scope of the present invention that the ballast vessel 70 may comprise additional valves (not shown) and conduits (not shown) which may connect to an external hydrogen supply source, thus providing an additional source of hydrogen to the system 20. While not shown, the recirculation loop/fluid handling system 72 additionally comprises a purge valve system for reducing the concentration of water and nitrogen in the recycle loop, as well as an optional humidification system. Additionally, as recognized by one of skill in the art, the fluid delivery 20 and hydrogen recirculation systems 72 will preferably be outfitted with check and/or isolation valves at appropriate locations in the system 20, which are not depicted herein.

In preferred embodiments of the present invention, the storage vessel 40 has at least one pressure sensor 78 and at least one temperature sensor 80. It is also preferred that a pressure sensor 82 is located either at the outlet 64 of the pressurization device 60 or within the connection passage 62 (as shown). It is also preferred that the ballast vessel 70 has a pressure sensor 84. Likewise, it is typical that the fuel cell stack 22 has one or more temperature and pressure probes (not shown), as well as flow meters (not shown). While not depicted in FIG. 1, the present invention may optionally comprise a flow meter at the outlet of the storage vessel 40 or at the outlet of the ballast vessel 70. Such pressure, temperature, and flow sensors enable monitoring of the system operations and automation of the system by controllers, as recognized by one of skill in the art.

Preferred embodiments of the present invention regulate pressurization device/compressor 60 operation by control loops using the gas pressure measured by a pressure sensor 82 at the compressor outlet 64 as a set point variable. Thus, in certain preferred embodiments, the compressor 60 will draw gas out of the storage vessel 40 at increasingly lower pressures to maintain a gas flow at a constant pressure. In this manner, the present invention enables release of hydrogen at both lower temperatures and pressures, and further compensates for decreasing equilibrium release pressure in the hydrogen storage material by likewise decreasing the surrounding environmental pressure, in essence drawing hydrogen gas out of the hydrogen storage material.

During recharge of the dehydrogenated hydrogen storage material, it is preferred that a high-pressure hydrogen supply is connected to the inlet conduit 42 connected to the inlet valve 44. The inlet valve 44 is opened and the outlet valve 46 is closed during the recharge process, to permit overpressure of the hydrogen gas inside the storage vessel 40, creating a greater differential pressure which facilitates a greater driving force and rate of charging or reabsorption of hydrogen gas. When hydrogen is released from the storage material, the inlet valve 44 is closed, to enable decreasing pressure in the hydrogen storage vessel 40.

While hydrogen gas is released by the hydrogen storage material from the storage vessel 40, the gas passes through the pressurization device 60, which increases the pressure (i.e., pressurizes) the hydrogen gas. It is preferred that the pressurization device 60 pressurizes the hydrogen gas to a level substantially commensurate, or in the alternative greater than, the pressure level of the fuel cell stack 22 during steady-state operation. During steady state operations, it is preferred that a pressure in the storage vessel 40 is less than the pressure in the fluid ballast vessel 70. It is also preferred that the pressure in the fluid ballast vessel 70 is greater than or equal to a pressure of the fuel cell 24 while it is in operation. It should be noted however, that the range of pressure values can vary significantly from the operating pressures of the fuel cell 24. Thus, during start-up conditions, for example, presently known start-up methods include feeding the hydrogen gas up to 30 atm absolute. Thus, the pressurization device 60 may provide pressurized gas through a wide range of pressure values, and further these values may change based upon the operating scenario selected. The pressurized hydrogen gas is then stored in the ballast vessel 70. The pressurized hydrogen gas is then delivered from the ballast vessel 70 to the fuel cell stack 22 anode inlet passage 32, as required at a predetermined pressurized level. One of the advantages of the present invention includes the addition of the ballast tank 70, which provides a buffer for varying load conditions of the fuel cell system 20. For example, the ballast vessel 70 preferably has sufficient capacity to provide additional hydrogen on demand during high load conditions. Thus, the storage vessel 40 is not dedicated to the fuel cell stack 22 and hydrogen delivery is not just in-time, permitting smooth continuous operations and operational flexibility.

In preferred embodiments of the present invention, the hydrogen storage material stores hydrogen in a substantially reversible manner. As used herein, the term “material” refers broadly to a substance containing at least the preferred chemical compound, but which may also comprise additional substances or compounds, including impurities. The term “composition” also broadly refers to matter containing the preferred compound or composition. By “substantially reversible” it is meant that the during the desorption reverse reaction (i.e. release of hydrogen), the material releases about 80% or greater of the hydrogen that was absorbed in the absorption reaction or forward reaction. This reversible process is known as hydriding. An example of a hydriding process is shown in Equation (1):

$$M ( s ) + \frac{y}{2} {H}_{2} ( g ) ⟷ {MH}_{y} ( s ) \qquad ( 1 )$$

where M(s) is a solid phase hydrogen absorption metal alloy, MH_{y}(s) is a solid phase metal hydride, and hydrogen (H₂(g)) is provided in gaseous form. Equation (1) is a solid-gas reaction process where hydrogen is absorbed during an exothermic charge reaction and is released during an endothermic discharge reaction. The stoichiometry is dependant on the composition and the overall charge of M, thus expressing the hydride as MH_{y} is more general formula where y is selected to provide charge balance. In a hydrogenated state, the hydrogen storage material stores absorbed hydrogen, which can subsequently be released in gaseous form, under appropriate temperature and pressure conditions. As the hydrogen is released, the hydrogen storage material forms a dehydrogenated state. After substantially all of the hydrogen gas has been released from hydrogen storage material, and substantially all of the material is dehydrogenated, the hydrogen storage material will need to be regenerated by exposure to hydrogen or in the alternative replaced with a new hydrogen storage material.

In various embodiments of the present invention, the hydrogen storage material reversibly stores and releases hydrogen, where recharging occurs by exposure to hydrogen gas so that the hydrogen storage material regenerates into a hydrogenated state. In preferred embodiments of the present invention, the hydrogen storage material is capable of being recharged with hydrogen from the dehydrogenated state to the hydrogenated state by subjecting the dehydrogenated state to hydrogen at industrially practical temperature and pressure conditions. Generally, such conditions include hydrogen pressure greater than atmospheric, and may entail temperatures greater than ambient. Such conditions are dictated by individual hydrogen storage material composition characteristics, and thus vary accordingly, as recognized by one of skill in the art.

In another embodiment, the hydrogen storage material releases hydrogen via an “irreversible” reaction (where the recharging conditions require significant additional processing or more extreme temperature and pressure conditions. Once an irreversible hydrogen storage material has released all of its hydrogen and is spent, it can be removed from the storage vessel 40 and replaced with a new hydrogen storage material charged with hydrogen.

Presently known storage materials that reversibly store hydrogen have reaction thermodynamics corresponding to an exothermic hydriding reaction and endothermic desorption/release reaction. Thus, in preferred embodiments of the present invention, the hydriding reaction is exothermic and the desorption/release reaction is endothermic, based upon presently known reversible hydrogen storage materials. However, the present invention is useful for any hydrogen storage materials that store hydrogen, and is not limited to solely those known reaction systems that have such reaction thermodynamics. Thus, in certain embodiments of the present invention, to facilitate the hydrogen release reaction where necessary, the present invention contemplates applying heat to the hydrogen storage material, as will be discussed below.

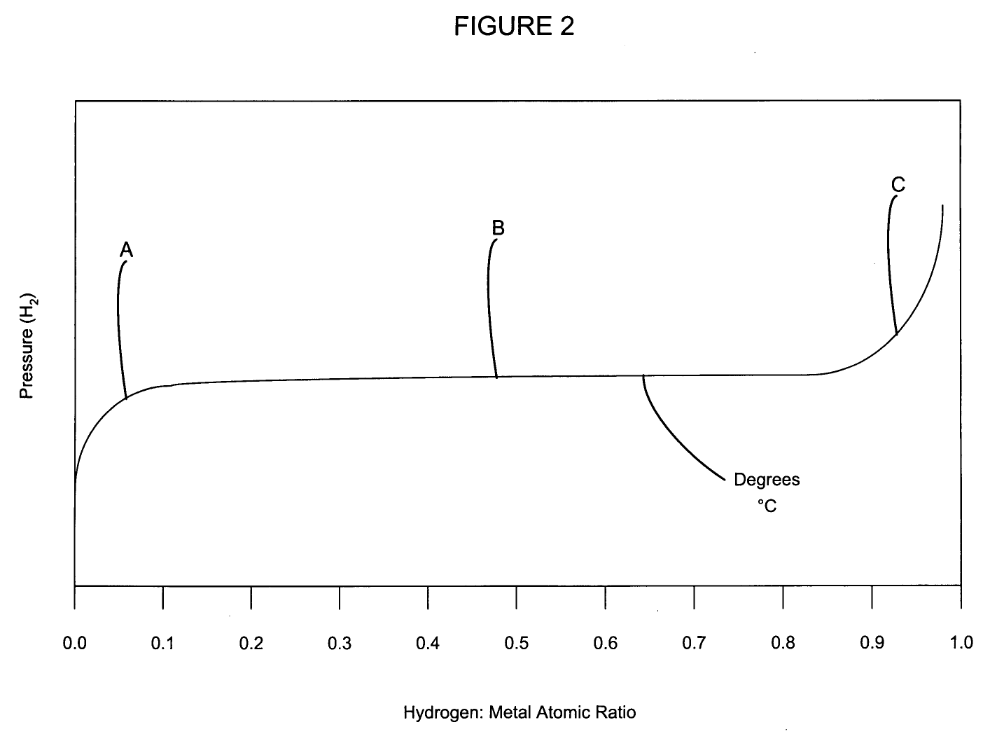

One aspect of the present invention is a reduction in the energy necessary to remove and release hydrogen from the hydrogen storage material. Selection of hydrogen storage materials generally focuses on the equilibrium pressure of the various hydrogen storage materials. As shown in FIG. 2, equilibrium pressure for absorption and desorption of hydrogen into an exemplary hydrogen storage material metal hydride over a range of concentrations of hydrogen in the metal alloy (expressed as the atomic ratio of hydrogen to metal) are shown at a constant temperature (i.e., an isotherm). At a given constant temperature, or isotherm, the concentration of hydrogen in the metal alloy increases (point A) with increasing hydrogen gas pressure. In the example shown, the equilibrium pressure reaches a relatively constant value through the range, indicated by B. Such a flat region of equilibrium pressure is generally referred to as a “plateau pressure”. Through the plateau pressure range B the hydrogen in the material condenses into a highly concentrated solid phase by reacting with the metal alloy and forming the hydride.

The pressure of hydrogen in the gas phase remains constant until the hydride phase occupies the whole volume of the hydrogen absorption material. Once the full capacity of the particular metal alloy is reached, hydrogen pressure in the gas increases again (point C). To reverse the process and release hydrogen from the metal alloy, the ambient gas pressure of the hydrogen in the environment surrounding the hydrogen absorption material is decreased below the equilibrium pressure, or the temperature of the material is raised such that it reaches a temperature where the external pressure is lower than the plateau pressure (point B), thereby favoring release of hydrogen. Temperature impacts the equilibrium pressure by shifting the isotherm curves to higher or lower pressures, accordingly.

One aspect of the present invention is the ability to maintain the fluid storage vessel 40 housing the hydrogen storage material at significantly different temperature and pressure condition than those required for the fuel cell stack 22. Previously, hydrogen storage materials and storage vessels 40 were in direct fluid communication with the fuel cell stack 22, and thus were required to desorb hydrogen at comparable temperature and pressure conditions to that of the operating conditions of the fuel cell 24. Hence, prior art hydrogen storage material selection dictated that the storage material release hydrogen at pressures comparable to the fuel cell 24 operating conditions (e.g., somewhere in the range of presently known fuel cell operating pressure conditions varying from 2 to 5 atm), thus having a relatively high equilibrium pressure. To achieve such higher equilibrium pressures, the material selected had to be capable of releasing hydrogen at a higher equilibrium pressure, and further had to be heated to a temperature corresponding to the high pressure (to a relatively high isotherm). Thus, the material generally had to be heated to high temperatures. Further, where a hydrogen storage material source is supplying hydrogen directly to the fuel cell stack 22, materials that were selected typically had a plateau pressure equilibrium pressure behavior as shown above in FIG. 2. The stable plateau equilibrium pressure enables release of hydrogen from the material at relatively constant pressure and temperature.

Preferred embodiments of the present invention permit the selection of a much larger class of hydrogen storage materials that have different material characteristics from prior art hydrogen storage material selections. Preferred embodiments of the present invention permit the fluid storage vessel 40 to have significantly different conditions from those of the fuel cell stack 22, which broadens the range of hydrogen material compositions that are suitable for use with the present invention. For example, materials may have vastly different absorption/desorption kinetics and equilibrium values, which do not have to be tailored to the fuel cell requirements (e.g., hydrogen does not need to be released at a high pressure corresponding to that of the fuel cell stack). Also, as appreciated by one of skill in the art, the hydrogen storage material's equilibrium pressure does not have to exhibit the plateau pressure configuration, but rather can have any configuration, because of the ability to decrease the pressure to near vacuum levels via the pressurization device 60.

Another advantage of the present invention, is that the hydrogen storage materials can release hydrogen at low pressures and temperatures, because the pressurization device/compressor 60 draws gases out of the fluid storage vessel 40, creating near vacuum conditions on the interior of the storage vessel 40. However, hydrogen storage materials each possess a characteristic minimum temperature, below which the material does not desorb or release hydrogen regardless of the surrounding pressure. Hydrogen delivery systems of the present invention are thus operated at conditions above such a minimum temperature for each individual hydrogen storage material. Further, the rate at which hydrogen is released by reaction kinetics of the hydrogen storage material is dependent upon temperature. Thus, a minimum temperature for the hydrogen storage material may likewise correspond to the minimum release rate needed to supply the fuel cell stack 22 with fuel (especially during high load requirements). Such a temperature is similarly dependent on the selection of the hydrogen storage material.

The present invention provides the ability to gauge the amount of hydrogen fuel remaining in hydrogen storage material. The fluid pressurization device 60 is regulated to have a constant outlet pressure (measured at 82). However, as the compressor 60 draws additional hydrogen out of the hydrogen storage material, thus decreasing its hydrogen content, the temperature and internal pressure in the storage vessel 40 required to extract additional hydrogen likewise changes. Thus, by monitoring the temperature and pressure (by sensors 78, 80) of the fluid storage vessel 40, a relationship can be established between these variables and the hydrogen concentration, by using the known PCT data for the hydrogen storage material. Other alternate methods of monitoring the quantity of hydrogen reactant remaining may include quantifying the flow rates in the outlet passage 48 and monitoring usage based upon known hydrogen storage capacities for the hydrogen storage material.

In one preferred embodiment of the present invention, the hydrogen storage material hydride is represented by the general formula M^{y}H_{y}, where M represents one or more cationic species other than hydrogen, and y represents the average valence state of M, where the average valence state maintains the charge neutrality of the compound. In accordance with the present invention, M represents one or more cationic species or a mixture of cationic species other than hydrogen. Thus, hydrogen storage materials according to the present invention contemplate M comprising a complex cation, which comprise two or more distinct cationic species. Cationic species that are preferred for all the preferred embodiments of the present invention include metal cations, as well as non-metal cations such as boron.

Certain hydrogen storage hydrides that are often referred to as complex hydrides comprise two cationic species, however one of the cationic species forms an anionic group with hydrogen, which further interacts with a second cationic species. This concept can be expressed by the following formula with a hydride expressed as M^{y}H_{y}, where M comprises two distinct cationic species, A and B, so that M=A+B. Thus, the hydride can be expressed as: A_{d}^{a}(B^{b}H_{c})ₐ^{-d} where (B^{b}H_{c}) is an anionic group, where d=(c−b) and a, b, c, and d are selected so as to maintain charge balance and electroneutrality of the compound. “A” is first cationic species which is preferably a rare earth metal or calcium (Ca), magnesium (Mg), or titanium (Ti), and “B” is a second cationic species which is preferably a transition metal or aluminum. Rare earth metals according to the present invention include lanthanum (La), neodynium (Nd), cerium (Ce), praseodymium (Pr) and transition metals may include: iron (Fe), tin (Sn), nickel (Ni), aluminum (Al), cobalt (Co), and manganese (Mn) and is also preferred. “A” may also be mischmetal (designated in the art as “Mm”) which is a commercially available mixture of rare earth elements, predominantly Ce, La, Nd, and Pr. Thus, preferred examples of complex hydrides have the nominal general formulas in a dehydrogenated state: AB, A₂B, AB₂ and AB₅. Non-limiting examples of such preferred compounds include: TiFe for AB; Mg₂Ni for A₂B; CaMg₂, ScFe₂, and TiCr_{1.4}V_{0.6} for AB₂; and LaNi₅ and MmNi₅ for AB₅. LaNi₅ is a particularly preferred hydrogen absorption metal alloy/low temperature hydride compound. Other useful hydrogen storage materials aside from those described above, include magnesium-containing or magnesium based metal hydrides. Useful examples include those described above under the A₂B category (e.g., Mg₂Ni), as well as magnesium metal (Mg) and its alloys.

Nitrogen based or nitrogen-containing hydrogen storage materials are also compatible with the present invention. Hydrogen storage materials that comprise nitrogen-containing compounds are contemplated for use with the present invention and include, for example, a hydrogen storage compound that comprises an imide which is represented by the formula M^{c}[(NH)⁻²]_{c/2} where M represents at least one cationic species other than hydrogen and c represents the average valence state of M, and upon hydriding forms an amide that is preferably represented by the general formula M^{c}[(NH)⁻¹]_{c}. Such nitrogen-containing hydrogen storage material systems are useful with the present invention, including those described in U.S. patent applications Ser. No. 10/603,474 filed on Jun. 25, 2003 and Ser. No. 10/649,923 filed on Aug. 26, 2003, which are incorporated herein by reference.

Other useful hydrogen storage material systems include hydrogen storage materials represented by the nominal general formula: M′ₓM″_{y}N_{z}H_{d} where (a) M′ is a cation selected from the group consisting of: Li, Ca, Na, Mg, K, Be, and mixtures thereof and x is greater than about 50 and less than about 53; (b) M″ comprises a cation composition comprising a Group 13 element of the Periodic Table and y is greater than about 5 and less than about 34; (c) N is nitrogen and z is greater than about 16 and less than about 45; (d) H is hydrogen and in a fully hydrogenated state, d is greater than about 110 and less than about 177; and (e) wherein M′, M″, x, y, z, and d are selected so as to maintain electroneutrality. Examples of particularly preferred hydrogen storage compounds represented by the above formula include lithium boron dinitrogen hydride (Li₃BN₂H₈). Such compounds are described by U.S. patent application Ser. No. 10/789,899 filed on Feb. 27, 2004, and herein incorporated by reference.

As shown in the embodiment in FIG. 1, the storage vessel is connected to a heat transfer device 90 (e.g., a heat exchanger). Such a heat transfer device 90 preferably circulates a heat transfer medium for heating, cooling, or both via a heat transfer circulation system (not shown). In the embodiments where the hydrogen storage material releases hydrogen by an endothermic mechanism and absorbs hydrogen by an exothermic mechanism, the heat transfer medium in the heat transfer device 90 transfers heat to the storage vessel 40 during hydrogen release (if necessary) or may remove heat from the storage vessel 40. The heat transfer device 90 may both apply and remove heat, as necessary. One aspect of the present embodiment is that by the compressor 60 drawing hydrogen out of the hydrogen storage material in the storage vessel 40, the pressure in the storage vessel 40 is lowered, thus requiring a relatively lower equilibrium temperature to release hydrogen. The heat transfer device 90 can be operated selectively, and preferably its operation is dependent upon a measured temperature in the storage vessel 40.

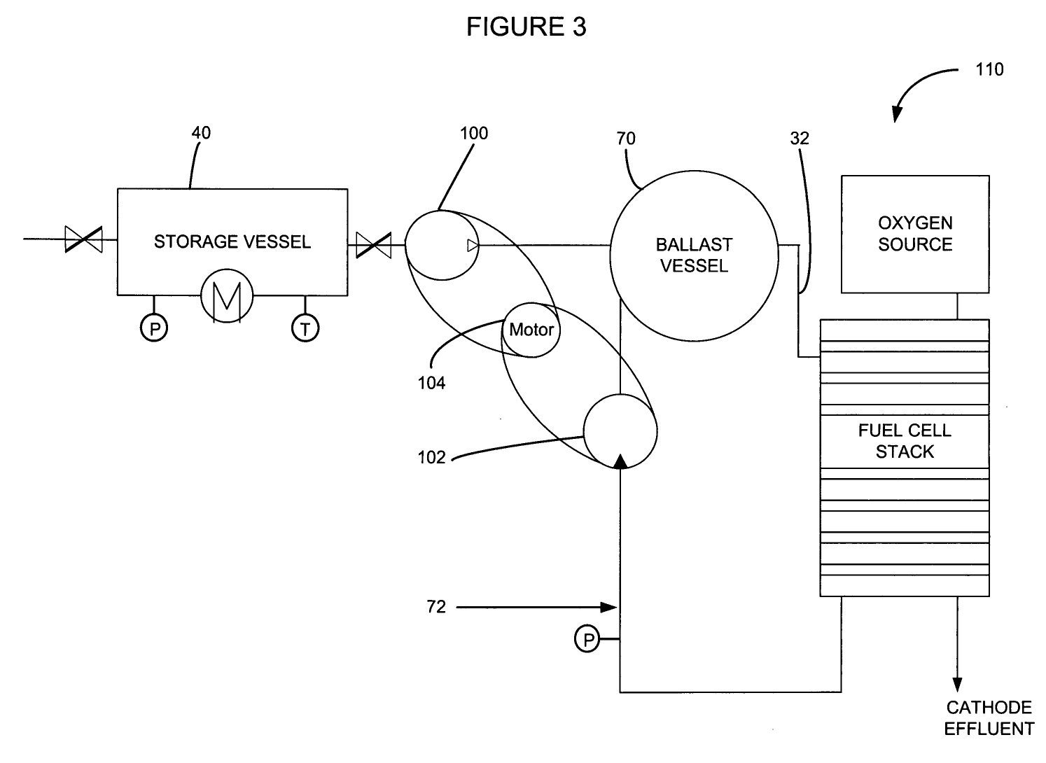

An alternate preferred embodiment of the present invention is shown in FIG. 3. In the embodiment shown, a fluid pressurization device 100 and a fluid handling system 102 share a common drive mechanism, or motor 104. The configuration of all other elements in the hydrogen delivery system 110 in the present embodiment are the same as those in the embodiment shown in FIG. 1. Thus, during operating conditions where the pressurization device/compressor 100 is not charging the ballast vessel 70 with pressurized hydrogen gas, the fluid handling system/pump 102 operates to circulate fluids through the fluid recirculation system 72 into the ballast tank 70. The drive mechanism 104 is preferably sized for power and duty requirements to enable simultaneous operation of both the fluid pressurization device 100 and the fluid handling system 102. As appreciated by one of skill in the art, the actual configuration of piping may vary from that shown, and may include bypass passages, including a bypass passage in the fluid handling system 72 to bypass the ballast vessel 70.

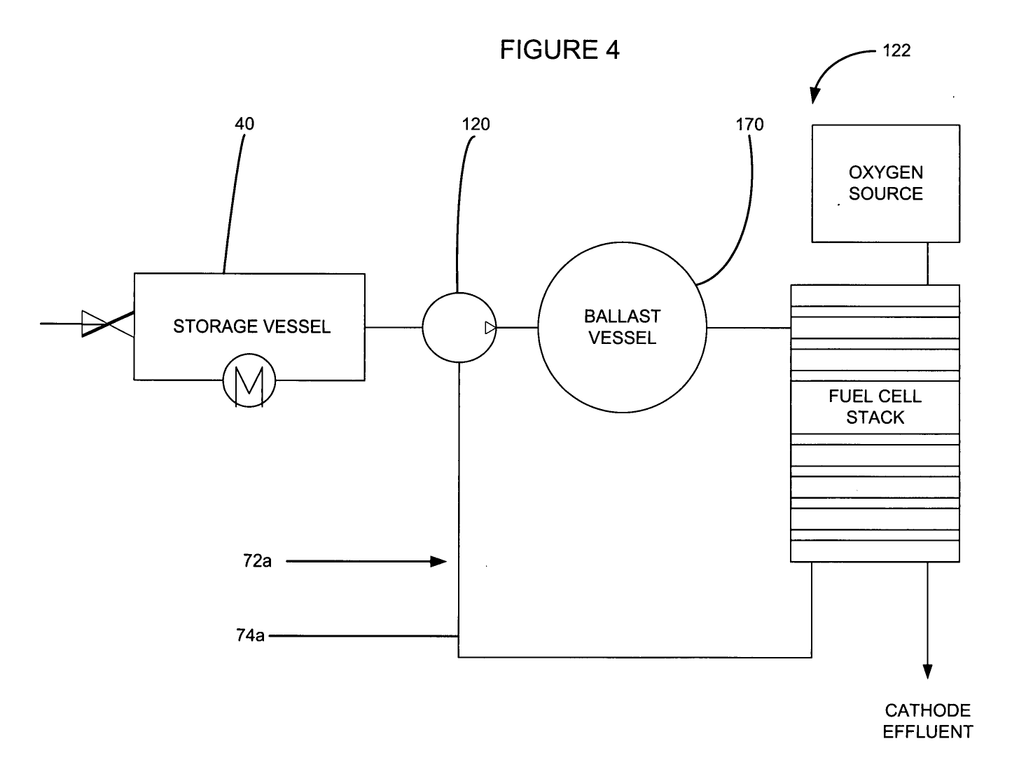

Yet another alternate preferred embodiment is shown in FIG. 4, where a fluid pressurization device and a fluid handling device are the same fluid processing apparatus 120. In this configuration, all additional elements in the reactant delivery system 122 are the same as those in FIG. 1, except that a fluid recirculation system 72a comprises a fluid recirculation passage 74a connecting to the fluid processing device 120, rather than to the ballast vessel 70, as in previous embodiments. Under operating conditions where the ballast vessel 70 must be recharged with pressurized hydrogen gas, the fluid processing apparatus 120 is used for fluid pressurization (as a compressor). However, where the fluid processing apparatus 120 is merely needed to circulate fluids in the fluid handling system/recirculation loop 72a, the fluid processing apparatus 120 is used as a pump or blower to transport fluids. Such a combined fluid processing apparatus 120 has an advantage of reducing the overall weight of the reactant delivery system 122 by combining functions and eliminating two separate devices.

The incorporation of the ballast vessel 70 better enables a fuel cell reactant delivery system (e.g., 20, 110, or 122) to respond to typical load requirement variations, by providing extra capacity of hydrogen gas for delivery thereto. Thus, in preferred embodiments, the residence time/storage capacity of the ballast vessel 70 is designed for fuel cell stack 22 consumption under high-load conditions, which is further dependent on the responsiveness of the hydrogen storage material and the rate of hydrogen release from the hydrogen storage material. As previously discussed, the ballast vessel 70 provides a particular advantage to the fuel delivery system (e.g., 20), because the fluid storage vessel 40 is not required to have identical operating conditions to the fuel cells 24 and stack 22, and the buffer tank/ballast vessel 70 enables delivery of a consistent high pressure hydrogen fuel delivery, without subjecting the fuel cell stack 22 to potential fluctuations in pressure and flow rate associated with the fluid storage vessel 40 as hydrogen is released from the hydrogen storage material.

Transient operating conditions within the fuel cell system generally pose challenges in the implementation of fuel cell technology. Such challenges are often due to low temperatures during start-up, for example, as well as low stoichiometry of reactants during low load conditions, which results in significantly lower heat release that slows the fuel cell from equilibrating at normal operating temperatures. In current PEM fuel cell applications, steady-state temperatures are about 70° C. to about 90° C. at typical operating pressures of between about 1 to about 5 atm absolute. Such heat released from the fuel cell stack 22 can be transferred to the fluid storage vessel 40 and used to facilitate release of hydrogen from the hydrogen storage material. However, start-up temperatures are generally below 60° C. at pressures generally less than 1 atm absolute. It is desirable for many fuel cell applications, that the fuel cells 24 can be started-up quickly so as to be immediately available to produce the energy needed, such as to propel a mobile application without significant delay. However, without such heat generated from the fuel cell stack 22, additional means for releasing hydrogen are useful.

Another alternate preferred embodiment according to the present invention includes a second hydrogen storage material (not shown) contained in the ballast tank 70, for use primarily during transient conditions. Preferred secondary hydrogen storage materials comprise those that are low-temperature storage materials that release hydrogen at low temperatures corresponding to start-up conditions. In such an embodiment, a portion of the ballast tank 70 houses the secondary hydrogen storage material. The secondary hydrogen storage material preferably reversibly stores hydrogen, and absorbs hydrogen at a pressure and temperature corresponding to steady-state operating conditions for the ballast vessel 70. Upon start-up, the ballast vessel 70 may deliver stored hydrogen gas to the fuel cell stack 22, and release hydrogen gas from the secondary hydrogen storage material housed therein, at the start-up temperature and ballast vessel pressure conditions indicated by pressure sensor 84. The secondary hydrogen storage material can also provide additional hydrogen to the fuel cell stack 22 during transient operations where the power demand is increased.

Many different alloys are capable of such a relatively low temperature hydriding process. Low temperature hydrogen charging is generally considered to be below about 60° C., and more specifically below 25° C. Certain preferred metal alloys that undergo hydrogen absorption to form hydrogenated hydrogen storage materials, such as metal hydrides, at preferred temperature and pressure conditions, according to the present invention, are known as “low-temperature hydrides” in the art. As discussed above, such hydrogen storage materials may also be selected for use as the hydrogen storage material in the fluid storage vessel 40, however such storage material selection for the fluid storage vessel 40 also focuses on other aspects of the hydrogen storage material, so that in addition to the temperature at which the material desorbs hydrogen (a primary consideration here for the ballast vessel 70 during start-up), the selection of fluid storage vessel 40 hydrogen storage materials includes assessing overall hydrogen capacity, hydrogen release rate, and equilibrium pressure behavior. Many of the low temperature metal hydrides, such as for example, lanthanium pentanickel (LaNi₅) are particularly suitable as a hydrogen storage material for the ballast vessel 70 to deliver hydrogen to the fuel cell stack 22 during start-up. Generally speaking, low temperature hydrides are recognized for having relatively low hydrogen capacity per unit weight than other hydrogen storage materials, and as such, are well suited for providing lower quantities of hydrogen in certain situations, such as start-up or during transient operating situations. It is generally more desirable to select a material having a higher hydrogen capacity and density for the main storage vessel 40.

Another advantage of the present invention is a surplus storage of hydrogen for use during start-up conditions. In prior art hydrogen storage fuel delivery systems, the hydrogen storage material must be heated to appropriate temperatures to facilitate release of hydrogen. With certain preferred embodiments of the present invention, however, the heat generated by the stack 22 during normal steady-state operations is optionally used after shut down to facilitate additional release of hydrogen from the hydrogen storage material in the fluid storage vessel 40. The hydrogen released after shut-down is pressurized by the fluid pressurization device 60 and stored in the ballast tank 70 at the appropriate pressure for hydrogen delivery. The stored hydrogen is then available immediately as a supply source for start-up of the fuel cell stack 22 during cold conditions. Thus, the waste heat and hydrogen dispelled by the fuel cell stack 22 and the storage vessel 40 after shut-down is efficiently used to ensure a hydrogen supply source during start-up.

The present invention further provides methods of providing hydrogen reactant to a fuel cell comprising releasing hydrogen gas from a hydrogen storage material and pressurizing the hydrogen gas. The pressurized hydrogen gas is stored in a ballast vessel and delivered from the ballast vessel to the fuel cells, where the pressurized hydrogen gas is at a pressure greater than or equal to an operating pressure of the fuel cells in the stack. In certain preferred embodiments, the releasing is conducted while applying heat to the hydrogen storage material. In alternate preferred embodiments, hydrogen is released from a second hydrogen storage material contained in the ballast vessel, preferably during start-up of the fuel cells in the stack. In various embodiments of the present invention, the methods comprise monitoring the amount of hydrogen fuel remaining in the storage vessel, to warn an operator of low fuel conditions prior to using all hydrogen stored in the hydrogen storage material. Such monitoring can be achieved by a variety of methods, including, by way of example, comparing the temperature and pressure in the storage vessel and relating it to the quantity of hydrogen remaining in the storage material by relating the data to known temperature and pressure conditions for the material through a range of hydrogen concentrations. Other methods of monitoring can be achieved by calculating the quantity of hydrogen consumed by measuring flow of hydrogen gas past a flow meter, measuring current output of the fuel cell, measuring and monitoring a duty cycle on a motor of a fluid handling device over short time intervals.

It is preferred that substantially all of the hydrogen gas present in the hydrogen storage material in the fuel cell is consumed prior to recharging. As such, the present invention contemplates charging the hydrogen storage material with a hydrogen supply source to provide hydrogen gas for absorption into the hydrogen storage material. In alternate preferred methods of the present invention heat is transferred between the fluid storage vessel and a heat transfer device during the releasing or charging of hydrogen, or both. Further, the present invention contemplates continuing to store hydrogen in the ballast vessel for a duration after ceasing fuel cell operations (when hydrogen is delivered).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A hydrogen delivery system comprising:
a fluid storage vessel for housing a hydrogen storage material that stores hydrogen;
a fluid ballast vessel for storing and delivering hydrogen to at least one fuel cell; and
a pressurization device adapted to pressurize said hydrogen released from said storage material for delivery to said ballast vessel, wherein said fluid storage vessel has a pressure less than or equal to said ballast vessel.

2. The hydrogen delivery system of claim 1, wherein said pressurized hydrogen is delivered in a fluid stream at a substantially constant pressure from said ballast vessel to said at least one fuel cell.

3. The hydrogen delivery system of claim 1, wherein said fuel cell comprises an anode assembly, said ballast vessel supplies hydrogen to an inlet of said anode assembly, and said ballast vessel receives effluent from an outlet of said anode assembly.

4. The hydrogen delivery system of claim 1, further comprising a fluid handling system for transporting fluids to and from said at least one fuel cell wherein said pressurization device and said fluid handling system share a common drive mechanism.

5. The hydrogen delivery system of claim 1, wherein said fluid pressurization device drives fluids through said ballast vessel and to said at least one fuel cell.

6. The hydrogen delivery system of claim 1, wherein said fluid ballast vessel is maintained at a substantially constant pressure.

7. The hydrogen delivery system of claim 1, wherein a first pressure in said fluid storage vessel is less than a second pressure in said fluid ballast vessel, and said second pressure is greater than or equal to a pressure of said at least one fuel cell while in operation.

8. The hydrogen delivery system of claim 1, wherein said hydrogen storage material has an equilibrium pressure that is less than a steady-state operating pressure of said at least one fuel cell.

9. The hydrogen delivery system of claim 1, wherein said hydrogen storage material reversibly stores said hydrogen by releasing said hydrogen via an endothermic reaction and re-absorbing hydrogen via an exothermic reaction.

10. The hydrogen delivery system of claim 1, wherein said fluid pressurization device drives fluid through a plurality of said fuel cells.

11. The hydrogen delivery system of claim 1, wherein said hydrogen storage material comprises a composition having the nominal general formula M^{y}H_{y}, where M represents one or more cationic species other than hydrogen and y represents the average valence state of M, where said average valence state maintains the charge neutrality of the compound.

12. The hydrogen delivery system of claim 1, wherein said hydrogen storage material is a hydride material having a dehydrogenated nominal general formula selected from the group consisting of: AB, A₂B, AB₂, and AB₅; wherein A is first cationic species and B is a second cationic species.

13. The hydrogen delivery system of claim 1, wherein said hydrogen storage material comprises a nitrogen-containing compound.

14. The hydrogen delivery system of claim 1, wherein said hydrogen storage material comprises a magnesium-containing compound.

15. The hydrogen delivery system of claim 1, wherein said hydrogen storage material comprises a composition selected from the group consisting of: lanthanum pentanickel (LaNi₅), magnesium nickel, (Mg₂Ni), lithium amide (LiNH), lithium boron dinitrogen hydride (Li₃BN₂H₈), lithium alanate (LiAlH₄), magnesium metal (Mg) and its alloys, and mixtures thereof.

16. The hydrogen delivery system of claim 1, wherein said ballast vessel further comprises a second hydrogen storage material that releases hydrogen during transient conditions of said fuel cell.

17. The hydrogen delivery system of claim 1, further comprising a heat transfer device in thermal communication with said fluid storage vessel.

18. The hydrogen delivery system of claim 1, further comprising one or more monitoring devices selected from: temperature monitoring devices, pressure monitoring devices, and fluid flow rate monitoring devices.

19. A hydrogen delivery system comprising:
a fluid storage vessel containing a hydrogen storage material that releases hydrogen gas;
a fluid pressurization device in fluid communication with said fluid storage vessel for pressurizing said released hydrogen gas;
a fluid ballast vessel adapted to receive and store said pressurized hydrogen gas from said fluid pressurization device; and
at least one fuel cell which uses said hydrogen gas as a reactant, wherein said pressurized hydrogen gas is delivered in a fluid stream at a substantially constant pressure from said ballast vessel to said at least one fuel cell.

20. The hydrogen delivery system of claim 19, wherein said at least one fuel cell comprises an anode assembly, said ballast vessel supplies said hydrogen gas to an inlet of said anode assembly, and said ballast vessel receives effluent from an outlet of said in assembly.

21. The hydrogen delivery system of claim 19, wherein said fluid pressurization device drives fluids through said ballast vessel and to said at least one fuel cell.

22. The hydrogen delivery system of claim 19, wherein a first pressure in said fluid storage vessel is less than a second pressure in said fluid ballast vessel, wherein said second pressure is substantially constant and is greater than or equal to a pressure of said at least one fuel cell while in operation.

23. A method of providing hydrogen reactant to a fuel cell comprising:
releasing hydrogen gas from a hydrogen storage material;
pressurizing said hydrogen gas;
storing said pressurized hydrogen gas in a ballast vessel; and
delivering said pressurized hydrogen gas from said ballast vessel to the fuel cell, wherein said pressurized hydrogen gas is at a pressure greater than or equal to an operating pressure of the fuel cell.

24. The method of claim 23, wherein said releasing is conducted while applying heat to said hydrogen storage material.

25. The method of claim 23, wherein during transient operating conditions additional hydrogen gas is released from a second hydrogen storage material contained in said ballast vessel.

26. The method of claim 23, further comprising monitoring an amount of hydrogen present in said hydrogen storage material.

27. The method of claim 23, further comprising consuming substantially all of said hydrogen gas from said hydrogen storage material in the fuel cell.

28. The method of claim 27, further comprising charging said hydrogen storage material with a hydrogen supply source to provide hydrogen gas to said hydrogen storage material.

29. The method of claim 23, wherein heat is transferred between said fluid storage vessel and a heat transfer device during said releasing, said charging, or both.

30. The method of claim 23, wherein after ceasing operations of the fuel cell, said storing continues for a duration longer than said delivering.

31. The method of claim 23, wherein an amount of hydrogen present in said hydrogen storage material is determined relative to a pressure and temperature of said hydrogen storage material in a hydrogen storage vessel.
